(19) United States
(12) Patent Application Publication
(10) Pub. No.: US 2011/0264428 A1
(43) Pub. Date: Oct. 27, 2011

(54) SYSTEM FOR STUDYING A HYBRID VEHICLE POWERTRAIN

(76) Inventors: Jérémy MALAIZE, Sainte-Genevieve-des-Bois (FR); Antonio Sciarretta, Rueil-Malmaison (FR); Youssef Touzani, Sevres (FR); Van Bui Tran, Massy (FR)

(21) Appl. No.: 13/083,644

(22) Filed: Apr. 11, 2011

(30) Foreign Application Priority Data
Apr. 21, 2010 (FR) 10/01692

(51) Int. Cl. G06G 7/63

(52) U.S. Cl. 703/8

(57) ABSTRACT

A system for studying a powertrain for a hybrid vehicle equipped with a thermal engine and an electric traction motor is disclosed including a first electric motor (M1), means (S1, S2) for real-time simulation of the operation of the thermal engine and for simulation of the thermal engine control means; and means (PTRI, M2) for reproducing mechanically the engine speed obtained from the simulation means on the rotating shaft of the first electric motor.

### BACKGROUND OF THE INVENTION

1. Field of the Invention

The present invention relates to the analysis and design of engines for vehicles. In particular, the invention relates to a system for studying a powertrain, of engine test bench type, for a hybrid vehicle equipped with a thermal engine and an electric traction motor.

2. Description of the Prior Art

The powertrain of a hybrid vehicle essentially includes a thermal engine and of an electric motor. The role of the electric motor is important regarding its contribution to propulsion, depending on the degree of hybridization of the vehicle (“stop/start”, “mild hybrid” or “full hybrid” . . . ).

Usually, the experimental apparatus allowing tests to be carried out on hybrid vehicle powertrains is referred to as “hybrid powertrain bench”. The thermal engines and electric motors mounted on the hybrid powertrain bench are those likely to really equip the vehicle. They are thus 1 to 1 scale engines.

These benches represent heavy investments in terms of costs and immobilizations. Furthermore, the fact that the hybrid vehicle powertrain is completely fixed in terms of architecture and components is a prerequisite for their realization. Thus, comparison of different architectures or of different component technologies cannot be made on such benches.

### SUMMARY OF THE INVENTION

The invention is a system for studying a powertrain, of engine test bench type, for a hybrid vehicle, which overcomes the drawbacks of “hybrid powertrain benches.” This is achieved with the system by combining a first electric motor with software for simulating the thermal engine.

The system according to the invention thus comprises:

a first electric motor (M1);
means (S1, S2) for real-time simulation of the operation of the thermal engine and for simulation of the thermal engine control means;
means (PTRI, M2) for reproducing mechanically an engine speed obtained from the real time simulation on the rotating shaft of the first electric motor.

According to the invention, the means for reproducing an engine speed can comprise a second electric motor (M2) fitted with a second rotating shaft secured to the rotating shaft of the first electric motor, and real-time interface means (PTRI) between the simulation and the first and second electric motors.

According to the invention, the interface means (PTRI) can comprise:

means for transmitting to the first electric motor (M1) a desired torque request for the first electric motor (M1);
means for transmitting to a vehicle transmission simulator (S3) a measurement of a torque really provided by the electric motor (M1);
means for transmitting to the second electric motor (M2) a rotating speed request from the vehicle transmission simulator (S3).

According to an embodiment, the interface means (PTRI) comprise a first electronic control means (OND1) connected to the first electric motor (M1), and a second electronic control means (OND3) connected to the second electric motor (M2). The electronic control means can comprise at least one inverter.

According to an embodiment, the real-time simulation comprises a computer provided with a real-time operating system, a real-time task supervisor, and software modules simulating in real time the operation of the thermal engine (S1), the control means of the thermal engine (S2), a transmission of the vehicle (S3) and dynamics of the vehicle (S4).

According to the invention, at least one of the rotation axles of the electric motors can be equipped with a torquemeter (CP) allowing measuring the real mechanical torque on the rotation axles.

According to a preferred embodiment, the first electric motor (M1) corresponds to a reduced scale of the electric traction motor, means (PTRI, M2) for reproducing an engine speed comprising software for accounting for scaling of the electric traction motor. The scale of the first electric motor (M1) can be reduced by a reduction factor of the order of 10 to 20 in relation to the electric traction motor. It can be an electric motor whose power is of the order of 2 kW.

### BRIEF DESCRIPTION OF THE DRAWING

Other features and advantages of the powertrain study system according to the invention will be clear from reading the description hereafter of embodiments given by way of non limitative examples, with reference to the accompanying figure.

FIG. 1 illustrates the system according to the invention for studying a powertrain of a hybrid vehicle.

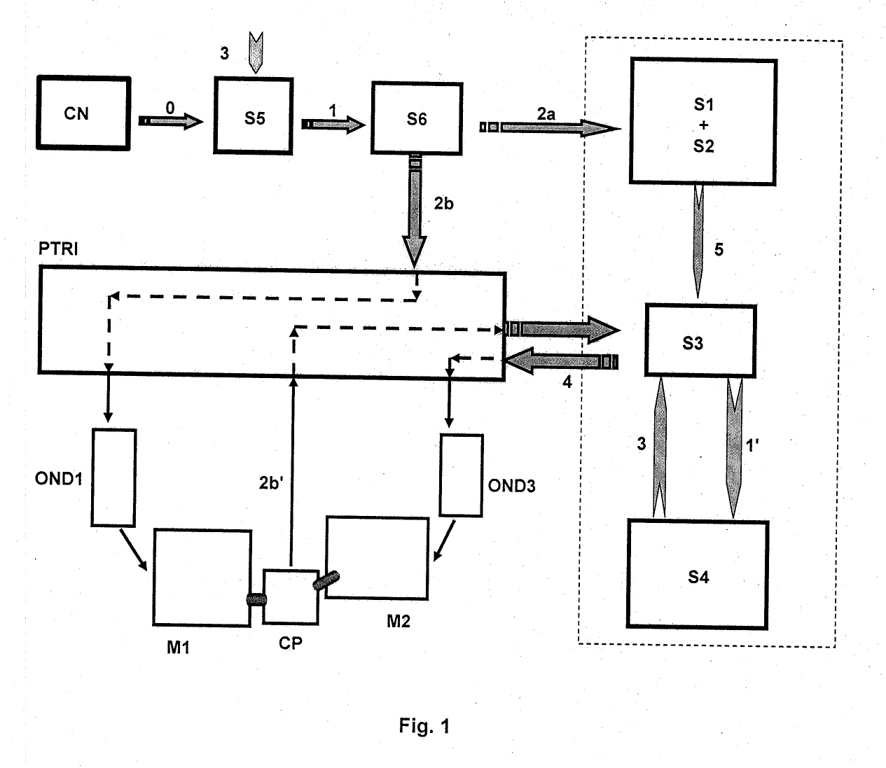

### DETAILED DESCRIPTION OF THE INVENTION

The powertrain of a hybrid vehicle comprises a thermal engine and an electric motor. During operation of a real hybrid vehicle, the electric traction motor produces a torque on its rotating shaft, to which is added algebraically further, after passage through various mechanical gear reduction devices, the torque produced by the thermal engine and the resisting torque imposed by the vehicle.

The study system according to the invention, which constitutes an engine test bench, allows reproduction of the operation of the hybrid powertrain under standard cycle conditions for a well-defined purpose. It comprises the following elements:

a first electric motor (M1);
means (S1, S2) for real-time simulation of the operation of the thermal engine and for simulation of the thermal engine control means; and
means (PTRI, M2) for reproducing mechanically the engine speed obtained from the means for real-time simulation on the rotating shaft of the first electric motor.

### First Electric Motor: Electric Traction Motor (M1)

The first electric motor is preferably a motor based on the same technology (synchronous or asynchronous, wound, permanent-magnet motor, etc.) as the powertrain electric traction motor. In fact, the purpose of this motor is to reproduce the behavior of the electric motor of the powertrain to be studied. The first electric motor can thus be the powertrain electric traction motor itself.

According to an embodiment, the system constitutes a small scale power engine test bench allowing reproduction of the operation of the hybrid powertrain under standard cycle conditions for a well-defined purpose. A first electric motor corresponding to a reduced scale of the powertrain electric traction motor is therefore used. The behavior of the electric motor of the powertrain to be studied, although of reduced dimension, is thus reproduced. It has a lower power than the powertrain electric motor, but by an identical behavior, at least in its trends. The behavior is considered to be identical when at least the electric power mapping (engine speed, torque and losses), the temperature variations and the dynamics (where the key factor is the temperature response time) of motor M1 reproduce—modulo the scale factors—those of the powertrain motor. The electric motor of the system reproduces the scale behavior of the real electric motor.

According to an example, the first electric motor of the bench (system), which simulates the electric traction motor of the hybrid vehicle, is a motor whose power is of the order of 2 kW, providing a reduction factor of the order of 10 to 20 in relation to the powertrain electric motor.

Building this electric motor thus requires a scaling operation so that the operation of the electric motor of the real hybrid powertrain can be represented by the first electric motor of the bench.

This electric motor scaling operation is carried out using known calculations described, for example, in the following document:

Fodorean D., Miraoui, A., Dimensionnement rapide des machines synchrones aimants permanents (MSAP), Techniques de l'Ingénieur, D 3 554-1-22.

In particular, some scale factors are imposed by the user according to the physical limits of the bench motors and of the hybrid powertrain motor. For example, the ratio between the torque measured on the bench and the torque levels in the powertrain to be represented, as well as the ratio between the rotating speed of the bench and that of the powertrain motor, are imposed.

Furthermore, some geometrical scale factors (ratio between the diameters, the lengths, etc.) remain fixed by the known geometry of the bench motor and that of the real powertrain to be represented. According to these imposed scale factors, the scale factors for other variables related to the electrical and thermal domains can be predicted.

Consequently, the behavior of the powertrain motor to be represented is reproduced identically to that of the bench motor, at least in its trends, in particular as regards the currents, the torque, and the thermal dynamics.

### Real-Time Simulation Means

The system according to the invention comprises means for real-time simulation of:
the operation of the thermal engine
the thermal engine control means
the transmission of the vehicle, and
the dynamics of the vehicle.

Real-time simulations provide an estimation on a 1 to 1 scale of the torque of the real thermal engine and of the resisting torque of the vehicle.

These simulations can be performed by a PC-type computer comprising a real-time operating system, a real-time task supervisor and real-time simulation software modules.

According to an embodiment, a PC in form of a 4U Industrial Rack having the following characteristics can be used:

PCIE9650-R11 IEI motherboard with Q6700 processor; Quad Core processor; Operating frequency: 2.66 GHz
real-time operating system and real-time task supervisor allowing execution of models up to frequencies of 10 kHz.

This computer provides execution of high-frequency real-time models by software modules.

The real-time 1 to 1 scale simulation software modules on-board the PC are:
S1. A Thermal Engine Simulator:

The inputs are the control signals, such as the injected fuel flow rate, and the engine rotating speed. The main output is the torque supplied to the transmission shaft. This simulator uses physical equations of the thermal engine under consideration, modelling both the combustion and the circulation of the various gases.

### S2. A Thermal Engine Control Means Simulator:

The inputs are the powertrain and engine measurements (speed, temperatures, fuel/air ratio, flow rates), the torque set point of the thermal engine and the non-measured quantities estimations. The outputs are the set points transmitted to the low-level actuators (throttle, injection, advance, turbo/EGR actuators, etc.). This simulator reproduces the thermal engine control laws.

The bench furthermore comprises the following simulators that are encountered in so-called “dynamic” real benches:
S3. A Vehicle Transmission Simulator:

The inputs are the torque of the thermal engine, the torque of the electric motor and the wheel speed. The outputs are the torque transmitted to the wheels and the speed of the vehicle.
S4. A Vehicle Dynamics Simulator:

The input is the total torque at the wheels. The output is the rotating speed of the wheels. This simulator reproduces the reaction of the vehicle according to the torques supplied by the simulated thermal engine and the real electric motor.
S5. A “Driver” Simulator:

The inputs are the speed of the vehicle and the desired speed. The output is the position of the pedals and therefore the total torque request set point. This simulator reproduces the driver's action on the pedals and a possible gearshift lever for following a driving cycle.

### S6. An Energy Supervisor:

This supervisor defines the strategies allowing distribution of the power required between the thermal engine and the electric motor. It generates and coordinates the set points supplied to the powertrain actuators so as to saturate the degrees of freedom provided by the hybrid architecture. In the case of a single-shaft parallel hybrid system (electric machine upstream from the box), one of the main functions of the energy supervisor is to fix the torque set point for the thermal engine and the electric motor in such a way that their sum is equal to the total torque requested by the driver. In general, the inputs are the desired torque request, the powertrain measurements (in particular the vehicle speed, the temperatures, etc.) and the estimations (especially the SOC). The outputs are the set points transmitted to the actuators (engine/clutch torque, gear ratio, conversion ratio set points in case of DC/DC converter, etc.).

Simulation of the aforementioned elements is performed in real time and is operated at the same time as the electric motor, in a coherent manner, so as to allow this assembly made up of both real and software elements to work identically to a 100% real hybrid powertrain.

During operation, when it is desired that the vehicle under test is to follow a standard driving cycle (which can be freely selected). The information exchanged by the constituent software modules of the bench is as follows:

E1. The driver, simulated by the “driver” simulator (S5), presses down on the accelerator and brake pedal, more or less sharply. The goal is that the simulated vehicle speed best follows the velocity profile (0) on a standard cycle (CN). The actions on these pedals are interpreted as a desired torque request (1) for the vehicle. This request is transmitted to the energy supervisor (S6).

E2. The measurement of the torque really applied to the vehicle (1′), that is, the algebraic sum of the torque (5) provided by the thermal engine simulator (S1) and of the torque (2b′) provided by the traction motor (M1), is calculated by the vehicle transmission simulator (S3). This resulting torque (Cr) is supplied to model S4. In general, this torque (Cr) differs from the requested torque (Cd), notably considering the various elements (described hereafter) to implement for a torque to be produced by the thermal engine and by the electric motor.

E3. From this stage on, part of the information is simulated, whereas the other part is obtained from the various measurements performed on the bench. This information is centralized on the real-time interface platform (PTRI).
a—A desired torque request for the thermal engine (2a) is transmitted to the thermal engine simulator (S1) and to the thermal engine control means simulator (S2). The thermal engine control simulator (S2) accounts for these requests, as well as information relative to the simulated thermal engine, coming from the thermal engine simulator (S1). The thermal engine control simulator (S2) determines, for example, the amount of fuel to be injected so that the thermal engine simulator (S1) provides the desired torque. The thermal engine simulator (S1) calculates the torque produced.
b—A desired torque request for the electric motor (2b) is transmitted to the real-time interface platform (PTRI) that redirects it to inverter OND1, after a scaling operation if need be, so that this torque can be produced by the electric motor (M1) physically present.
c—The torque really supplied (2b′) by the electric motor (M1) is measured by a torquemeter (CP) and redirected to the vehicle transmission simulator (S3), possibly after scaling if need be by the real-time interface platform (PTRI).

E4. The vehicle dynamics simulator (S4) calculates the real speed of the vehicle (3), to be compared with the speed to be followed on the cycle. This speed results from the previous torque, but also from the various frictions and aerodynamic resistances of the vehicle.

E5. According to the gear ratio selected, a rotating speed of the various transmission elements and more particularly a rotating speed of the traction motor (M1) corresponds to the speed of the vehicle. This rotating speed of the electric motor (4) is simulated by the vehicle transmission simulator (S3).

E6. This rotating speed (4) is sent to the real-time interface platform (PTRI) that controls generator (M2), via inverter OND3, so that the shaft of the traction motor (M1) operates at the desired rotating speed.

Means for Reproducing Mechanically a Rotating Speed Obtained from Simulations

According to an embodiment, the means for reproducing mechanically the rotating speed obtained from the simulator on the rotating shaft of the first electric motor comprises:

a second electric motor provided with a second rotating shaft secured to the rotating shaft of the first electric motor; and
real-time interface means (PTRI) between the simulator and the first and second electric motors.

### Real-Time Interface Means (PTRI)

The interface means are a real-time platform based on software and electronic components, comprising:

means for transmitting to the first electric motor (M1) the desired torque request for the first electric motor (M1);
means for transmitting to the vehicle transmission simulator (S3) the measurement of the torque really produced by the electric motor (M1); and
means for transmitting to the second electric motor (M2) the rotating speed request from the vehicle transmission simulator (S3).

This real-time platform allows the software modules to interface with all the electronic and mechanical components of the bench.

In the embodiment where the first electric motor (M1) corresponds to a reduced scale of the electric traction motor, the real-time interface means (PTRI) also comprises software accounting for this scaling.

This platform is connected to the first electric motor and to the second electric motor. It centralizes the various measurements performed on the bench, possibly with selective filtering so as to reject noises relative to the measurement of torque, engine speed, engine rotor position, voltages and electric currents. This platform transmits the torque request concerning the electric traction motor to this electric motor. It also compares the speed at which the electric traction motor has to run with the measured speed value, and it requests the required torque from the generator (second electric motor of the bench) so that the rotating shaft of the first electric motor runs at the desired rotating speed value.

This platform is also connected to the computer by a CAN link. It also receives information from the computer concerning the torque to be provided by the electric traction motor (by CAN link) and concerning the speed at which the electric traction motor has to run (by CAN link).

According to an example, the real-time interface platform is the ACEbox© control system (IFP, France).

### Second Electric Motor: The Generator (M2)

Within the system according to the invention, the torque of the real thermal engine and the resisting torque of the vehicle are numerical values resulting from real-time simulations (and not physical torques). A second electric motor can be used to reproduce their contribution on the shaft of the electric traction motor on a reduced scale (first electric motor of the bench). This second motor is connected to the first electric motor of the bench. This second electric motor is referred to as generator. It is possible to use for example an electric motor whose power is of the order of 10% higher than that of the first motor.

The rotating shafts of the first and second electric motors are secured to one another.

According to an embodiment, the two shafts are secured to one another by means of a semi-rigid coupling (mechanical bellows for example).

According to another embodiment, a single rotating shaft common to the two electric motors is used.

The function of this second electric motor (generator) thus is to convert to a real torque, and possibly on a small scale, the torque values resulting from real-time 1 to 1 scale simulations of the motor and of the vehicle.

The rotating speed of the electric motor of the real hybrid powertrain is therefore calculated from the simulated vehicle speed. This rotating speed is obtained after passage through various mechanical gear reduction devices. The rotating speed is then scaled if need be so that it can be reproduced on the low-power bench by means of the second electric motor directly mounted on the shaft of the traction motor. The electric traction motor “sees” the effect produced by the powertrain on the vehicle which is an effect that is expressed by the speed thereof.

### Connectivity: Electric Architecture

The power electronics controlling the two electric motors is four inverters. The functionalities of each inverter are as follows:

inverter OND1 controls the electric traction motor M1. It is connected to electric traction motor M1 and to the real-time interface platform via a CAN link and analog channels
inverter OND2 fulfils two functions which are emulation of the electric energy source (battery or supercapacitor) and reinjection of the current into the network when electric traction motor M1 works as a generator;
inverter OND3 controls second electric motor M2 that emulates the thermal engine and the behavior of the vehicle. It is connected to second motor M2 and to the real-time interface platform via a CAN link and analog channels; and
inverter OND4 provides reinjection of the current into the electric distribution network (EDF® for example) upon braking of second electric motor M2.

An autotransformer is preferably inserted between the electric distribution network and inverter OND2 to allow regulation of the continuous bus voltage of inverter OND1 between 300 V and 400 V. Thus, inverter OND2 can emulate the fluctuations of a battery voltage.

It is also possible to use a manual source switch so as to allow to switch to a real battery. This allows to work on the complete electric traction chain in the bench.

Inverters OND2 and OND4 work in PFC (Power Factor Corrector) mode to provide a sinusoidal current in phase with the voltage of the electric network in the two operating modes: traction and regeneration. In the latter case, LC circuits (inductive capacitive) are used for filtering the current and voltage harmonics due to the PWM modulation.

RFI filters contribute to reduce the emission level of radio-frequency signals on the feeder cables between the electric distribution network and inverters OND2 and OND4.

Inverters OND1 and OND3 are dedicated only to the control of the respective electric motors M1 and M2. These two inverters are open platforms that can adapt to any type of alternating-current machine.

Thus, torque low-level control, modulation frequency and acquisitions can be adapted and optimized for any type of electric machine. This allows variation of the engines of the bench within all the electric motor technology ranges.

### Particular Bench Embodiment Example

A bench embodiment example comprises the following mechanical elements:

concerning the electric motors:
a first electric motor M1, referred to as traction motor, with a power of 1.76 kW, from the Leroy-Somer UniDrive range;
a second electric motor M2, also referred to as generator, with a power of 2.51 kW, also from the Leroy-Somer UniDrive range;
   concerning the mechanical support:
two metal supports (also referred to as brackets), one for each machine, rigidly fastened to an aluminium plate, itself secured to a base frame by means of the required screws and bolts;
   concerning the coupling between the electric motors:
a semi-rigid coupling for securing to one another the respective axles of each electric machine; and
a torquemeter allowing measurement of the real mechanical torque on the rotating axle of the electric motors.

### Use of the Bench

### Hybrid Powertrain Pre-Dimensioning

This system allows evaluation of several possible options for the powertrain engine while using a single engine on the bench. A set of different scale factors supposed to reproduce the main trends of the static and dynamic behavior of the real powertrain corresponds to each option. This allows using the system according to the invention as a pre-dimensioning tool for a hybrid powertrain.

### Design of the Electric Traction Motor Control

It is the most obvious use of the system, based on the idea that the physical element is the most representative of reality in a half-real and half-software assembly. The tests are therefore naturally conducted on this real element. In our case, the real physical element being the electric motor, the first use of the bench is the study of the electric motor of a known hybrid powertrain. In this powertrain:

the thermal engine is known, as well as its real-time models; and
the electric motor of the powertrain is known.

In this context, the objective is to design the control of the powertrain electric motor by carrying out tests on a motor identical to the powertrain motor, but with a reduced scale, and for which the conditions of use are the same—modulo the scale factors—as those of the powertrain motor. The user, who is the designer of the electric motor control, will have, with the reduced scale bench, a fuel consumption value comparable to the value that would be obtained on the real hybrid powertrain bench.

### Power Distribution Adaptation to the Various Electric Motors

According to this use, the starting point is from a determined power distribution module for a given electric motor, a given thermal engine, which, with the two thermal engine and electric motor control modules, gives a satisfactory fuel consumption in a standard driving cycle. A context is then selected where, by varying the electric motor within its range, the best power distribution possible is maintained. That is to find the power distribution providing a satisfactory fuel consumption value despite the place change of the electric motor in its range (motor with the same manufacturing technology, but with different dimensions, therefore a different power).

By varying the scaling factors of the electric traction motor of the bench, other electric motors are emulated in the range under study, which allows adapting or the power distribution so that it remains optimum despite the dimensional variation of the electric motor.

Thus, another use of the small scale power bench is aiding the development of the optimum power distribution module. The development is one that adapts to the dimensional changes of the electric motor for example. Determining an optimum power distribution strategy for each dimensioning selection for the powertrain electric motor allows evaluation and comparing different choices, but always under their best operating conditions.

1-10. (canceled)

11. A system for studying a powertrain for a hybrid vehicle equipped with a thermal engine and with an electric traction motor comprising:
a first electric motor;
means for real-time simulation of the operation of the thermal engine and for simulation of a control of the thermal engine; and
means for reproducing mechanically an engine speed obtained from the means for simulation on a rotating shaft of the first electric motor.

12. A system as claimed in claim 11, wherein the means for reproducing an engine speed comprises a second electric motor including a second rotating shaft secured to the rotating shaft of the first electric motor, and a real-time interface between the means for simulation and the first and second electric motors.

13. A system as claimed in claim 12, wherein the real-time interface comprises:
means for transmitting to the first electric motor a desired torque request for the first electric motor;
means for transmitting to a vehicle transmission simulator a measurement of a torque really provided by the electric motor; and
means for transmitting to the second electric motor a rotating speed request from the vehicle transmission simulator.

14. A system as claimed in claim 12, wherein the interface comprises a first electronic control connected to the first electric motor, and a second electronic control connected to the second electric motor.

15. A system as claimed in claim 13, wherein the interface comprises a first electronic control connected to the first electric motor, and a second electronic control connected to the second electric motor.

16. A system as claimed in claim 14, wherein each electronic control comprises at least one inverter.

17. A system as claimed in claim 15, wherein each electronic control comprises at least one inverter.

18. A system as claimed in claim 11, wherein the means for real-time simulator comprises a computer including a real-time operating system, a real-time task supervisor, and software modules simulating in real time operation of the thermal engine, the control means of the thermal engine, a transmission of the vehicle and dynamics of the vehicle.

19. A system as claimed in claim 12, wherein the means for real-time simulator comprises a computer including a real-time operating system, a real-time task supervisor, and software modules simulating in real time operation of the thermal engine, the control means of the thermal engine, a transmission of the vehicle and dynamics of the vehicle.

20. A system as claimed in claim 13, wherein the means for real-time simulator comprises a computer including a real-time operating system, a real-time task supervisor, and software modules simulating in real time operation of the thermal engine, the control means of the thermal engine, a transmission of the vehicle and dynamics of the vehicle.

21. A system as claimed in claim 14, wherein the means for real-time simulator comprises a computer including a real-time operating system, a real-time task supervisor, and software modules simulating in real time operation of the thermal engine, the control means of the thermal engine, a transmission of the vehicle and dynamics of the vehicle.

22. A system as claimed in claim 15, wherein the means for real-time simulator comprises a computer including a real-time operating system, a real-time task supervisor, and software modules simulating in real time operation of the thermal engine, the control means of the thermal engine, a transmission of the vehicle and dynamics of the vehicle.

23. A system as claimed in claim 16, wherein the means for real-time simulator comprises a computer including a real-time operating system, a real-time task supervisor, and software modules simulating in real time operation of the thermal engine, the control means of the thermal engine, a transmission of the vehicle and dynamics of the vehicle.

24. A system as claimed in claim 17, wherein the means for real-time simulator comprises a computer including a real-time operating system, a real-time task supervisor, and software modules simulating in real time operation of the thermal engine, the control means of the thermal engine, a transmission of the vehicle and dynamics of the vehicle.

25. A system as claimed in claim 11, wherein at least one rotational axle of the electric motors includes a torquemeter for measuring real mechanical torque on the at least one rotation axle.

26. A system as claimed in claim 12, wherein at least one rotational axle of the electric motors includes a torquemeter for measuring real mechanical torque on the at least one rotation axle.

27. A system as claimed in claim 13, wherein at least one rotational axle of the electric motors includes a torquemeter for measuring real mechanical torque on the at least one rotation axle.

28. A system as claimed in claim 14, wherein at least one rotational axle of the electric motors includes a torquemeter for measuring real mechanical torque on the at least one rotation axle.

29. A system as claimed in claim 16, wherein at least one rotational axle of the electric motors includes a torquemeter for measuring real mechanical torque on the at least one rotation axle.

30. A system as claimed in claim 18, wherein at least one rotational axle of the electric motors includes a torquemeter for measuring real mechanical torque on the at least one rotation axle.

31. A system as claimed in claim 11, wherein the first electric motor is a reduced scale of the electric traction motor and includes means for reproducing an engine speed comprising software for accounting for scaling of the electric traction motor.

32. A system as claimed in claim 31, wherein the scale of the first electric motor has a reduced scale of 10 to 20 in relation to the electric traction motor.

33. A system as claimed in claim 32, wherein the first electric motor comprises an electric motor with power on the order of 2 kW.
